(19) United States
(12) Patent Application Publication
(10) Pub. No.: US 2010/0265605 A1
(43) Pub. Date: Oct. 21, 2010

(54) COLOR FILTER

(75) Inventor: Ming-Shu Lee, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/488,599

(22) Filed: Jun. 22, 2009

(30) Foreign Application Priority Data
Apr. 21, 2009 (TW) 98113202

(51) Int. Cl. G02B 5/22

(52) U.S. Cl. 359/891

(57) ABSTRACT

A color filter including a substrate, a light-shielding layer, a plurality of first color filter patterns and a plurality of second color filter patterns is provided. The light-shielding layer has a plurality of openings arranged in array, and the substrate is exposed by the openings. The first color filter patterns and the second color filter patterns are arranged in interlace and parallel. The first color filter patterns are disposed on a part of the openings and are overlapped to the neighboring light-shielding layer, and there is a first overlap width between the first color filter patterns and the light-shielding layer. The second color filter patterns are disposed on another part of the openings and are overlapped to the neighboring light-shielding layer, and there is a second overlap width between the second color filter patterns and the light-shielding layer. The second overlap width is not equal to the first overlap width.

### CROSS-REFERENCE TO RELATED APPLICATION

This application claims the priority benefit of Taiwan application serial no. 98113202, filed on Apr. 21, 2009. The entirety of the above-mentioned patent application is hereby incorporated by reference herein and made a part of specification.

### BACKGROUND OF THE INVENTION

1. Field of the Invention

The present invention relates to a filter structure. More particularly, the present invention relates to a color filter.

2. Description of Related Art

Regarding a display apparatus having color filters, the color filter is mainly formed by a substrate, a light-shielding layer disposed on the substrate and a plurality of color filter patterns, wherein a color image displayed on the display apparatus is generated when backlight or environmental light passes through the color filter patterns. Generally, the light-shielding layer can be used for shielding a color mixing phenomenon generated between the color filter patterns of different colors. In other words, the light-shielding layer is disposed between two adjacent color filter patterns.

During actual applications, when the color filter is fabricated, the light-shielding layer having a plurality of openings is first formed on the substrate, and then the color filter patterns are filled in the openings. However, during an actual fabrication process, a fabrication error (for example, an alignment error) is inevitable, so that actual positions of the color filter patterns are slightly deviated from ideal positions, and therefore the color filter patterns cannot be fully filled in the openings, which may leads to a poor light-shielding effect of the light-shielding layer, or even a light leakage phenomenon of the color filter.

To avoid defects of the color filter caused by the fabrication error, the color filter patterns are generally overlapped to the light-shielding layer to avoid the light leakage of the color filter. However, an overlapped degree between the color filter patterns and the light-shielding layer can influence a surface evenness of the color filter pattern, and accordingly influence a refraction of the backlight or the environmental light passing through the color filter pattern. Once the light is undesirably refracted when passing through the color filter pattern, an optical quality of the color filter is greatly reduced.

### SUMMARY OF THE INVENTION

The present invention is directed to a color filter, in which sizes of overlapped parts between color filter patterns of different colors and a light-shielding layer are different, so that the color filter may have a good optical quality.

The present invention provides a color filter including a substrate, a light-shielding layer, a plurality of first color filter patterns and a plurality of second color filter patterns. The light-shielding layer is disposed on the substrate, wherein the light-shielding layer has a plurality of openings arranged in an array, and the substrate is exposed by the openings. The first color filter patterns are disposed on the substrate in parallel, wherein the first color filter patterns are located on a part of the openings and are overlapped to the neighboring light-shielding layer, and there is a first overlap width between each of the first color filter patterns and the light-shielding layer. The second color filter patterns are disposed on the substrate and are arranged in interlace and parallel to the first color filter patterns, wherein the second color filter patterns are located on another part of the openings and are overlapped to the neighboring light-shielding layer, and there is a second overlap width between each of the second color filter patterns and the light-shielding layer. The second overlap width is not equal to the first overlap width.

In an embodiment of the present invention, the first color filter patterns are overlapped to the light-shielding layer by extending to edges of the part of the openings and top of the neighboring light-shielding layer, and the second color filter patterns are overlapped to the light-shielding layer by extending to edges of the other part of the openings and the top of the neighboring light-shielding layer.

In an embodiment of the present invention, the second overlap width is greater than the first overlap width. In an embodiment, there is the first overlap width between each of the first color filter patterns and the light-shielding layer along a short side direction, and there is the second overlap width between each of the second color filter patterns and the light-shielding layer along the short side direction. The first color filter pattern has a first line width along the short side direction, and the second color filter pattern has a second line width along the short side direction. In an embodiment, the second line width is greater than the first line width.

In an embodiment of the present invention, the first overlap width is between 1-5 microns, and the second overlap width is between 6-10 microns.

In an embodiment of the present invention, a ratio between the second overlap width and the first overlap width is 8:3.

In an embodiment of the present invention, each of the first color filter patterns includes a red filter pattern and a blue filter pattern, and each of the second color filter patterns includes a green filter pattern, wherein the red filter patterns, the green filter patterns and the blue filter patterns are arranged in interlace and parallel.

In an embodiment of the present invention, the color filter further includes a plurality of third color filter patterns. The third color filter patterns are disposed on the substrate, and are arranged in interlace and parallel to the first and the second color filter patterns. Moreover, the third color filter patterns are located on the rest part of the openings and are overlapped to the neighboring light-shielding layer, wherein there is a third overlap width between each of the third color filter patterns and the light-shielding layer. The first, the second and the third overlap widths are not equal.

In an embodiment of the present invention, the third color filter patterns are overlapped to the light-shielding layer by extending to edges of the rest part of the openings and the top of the neighboring light-shielding layer.

In an embodiment of the present invention, the second overlap width is greater than the first overlap width and the third overlap width, though the first overlap width is not equal to the third overlap width. In an embodiment, there is the first overlap width between each of the first color filter patterns and the light-shielding layer along a short side direction, there is the second overlap width between each of the second color filter patterns and the light-shielding layer along the short side direction, and there is the third overlap width between each of the third color filter patterns and the light-shielding layer along the short side direction. The first color filter pattern has a first line width along the short side direction, the second color filter pattern has a second line width along the short side direction, and the third color filter pattern has a third line width along the short side direction. In an embodiment, the second line width is greater than the first and the third line widths, though the first line width is not equal to the third line width.

In an embodiment of the present invention, the first color filter pattern is a red filter pattern, the second color filter pattern is a green filter pattern, and the third color filter pattern is a blue filter pattern. The red filter patterns, the green filter patterns and the blue filter patterns are arranged in interlace and parallel.

Accordingly, in the color filter of the present invention, sizes of the overlapped parts between the color filter patterns of different colors and the light-shielding layer are different, so that the color filter may have a good optical quality. By applying the color filter of the present invention to a display apparatus, display quality of the display apparatus can be effectively improved.

In order to make the aforementioned and other features and advantages of the present invention comprehensible; several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial top view of a color filter according to an embodiment of the present invention.

FIG. 2 is a diagram illustrating a relation between color filter patterns and a light-shielding layer in any pixel region of FIG. 1.

FIG. 3 is a partial cross-sectional view along a section line L1-L2 of FIG. 2.

FIG. 4 is a partial top view of a color filter according to another embodiment of the present invention.

### DESCRIPTION OF EMBODIMENTS

### First Embodiment

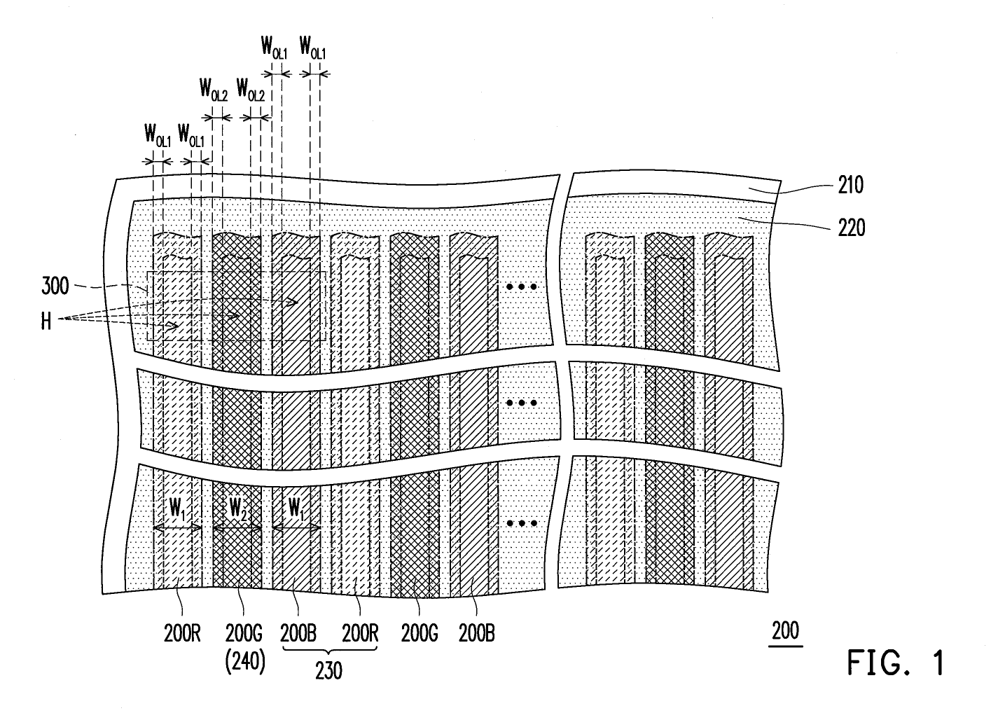

FIG. 1 is a partial top view of a color filter according to an embodiment of the present invention. Referring to FIG. 1, the color filter 200 includes a substrate 210, a light-shielding layer 220, a plurality of first color filter patterns 230 and a plurality of second color filter patterns 240, wherein the light-shielding layer 220, the first color filter patterns 230 and the second color filter patterns 240 are disposed on the substrate 210, and the first color filter patterns 230 and the second color filter patterns 240 are arranged in interlace and parallel. Certainly, the color filter 200 of the present embodiment can further includes other components, though the other components are not illustrated in FIG. 1 for simplicity's sake.

Generally, an image displayed by a display apparatus can be formed by three primary colors of light (red light, green light, and blue light), wherein the three primary colors are generated when light passes through the color filter having the three primary colors. In the color filter 200 of the present embodiment, the first color filter pattern 230 and the second color filter pattern 240 are, for example, a red, a green and a blue filter pattern, though the present invention is not limited thereto.

In detail, in the present embodiment, each of the first color filter patterns 230 includes a red filter pattern 200R and a blue filter pattern 200B, and each of the second color filter patterns 240 includes a green filter pattern 200G, wherein the red filter pattern 200R, the green filter pattern 200G and the blue filter pattern 200B are arranged in interlace and parallel.

Next, the color filter 200 of the present embodiment is described in a microscopic point of view based on a relation between the color filter patterns and the light-shielding layer 220 in any pixel region 300 of the color filter 200.

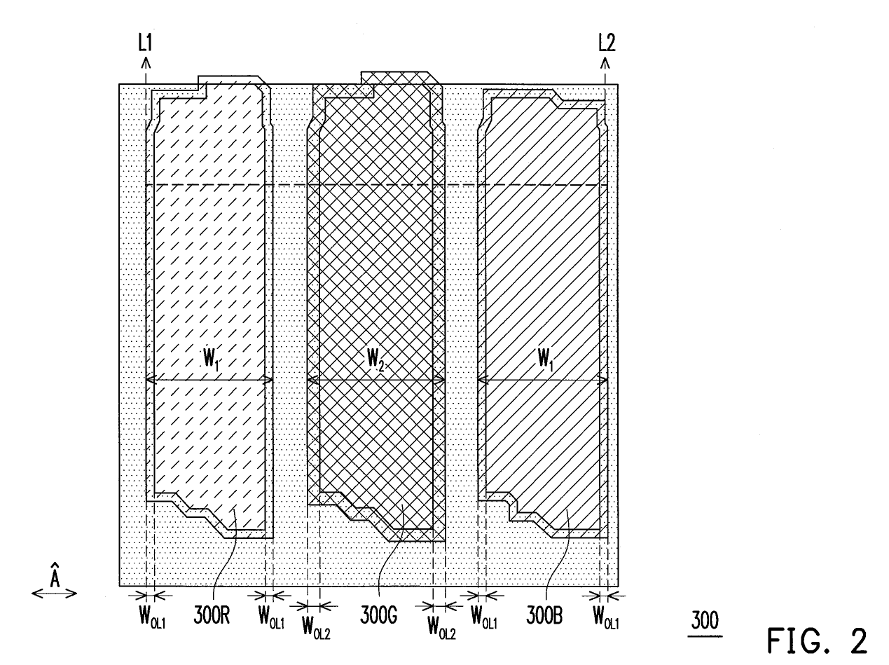

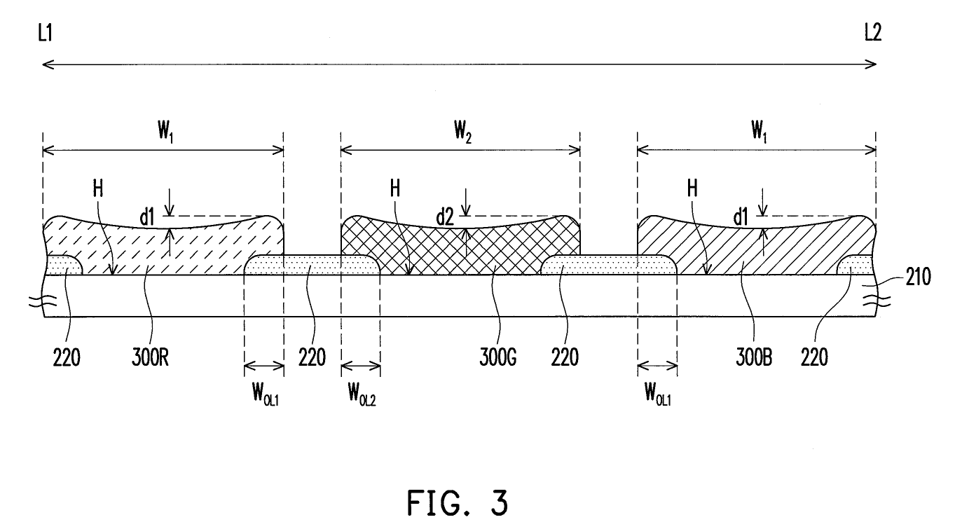

FIG. 2 is a diagram illustrating a relation between the color filter patterns and the light-shielding layer in any pixel region of FIG. 1, and FIG. 3 is a partial cross-sectional view along a section line L1-L2 of FIG. 2. Referring to FIG. 2 and FIG. 3, in the present embodiment, the light-shielding layer 220 has a plurality of openings H arranged in array, wherein the substrate 210 is exposed by the openings H, and the red filter pattern 300R, the green filter pattern 300G and the blue filter pattern 300B are located on the openings H and are overlapped to the neighboring light-shielding layer 220. Namely, the first color filter pattern 230 of FIG. 1 that is formed by the red filter pattern 200R and the blue filter pattern 200B is located on a part of the openings H, and is overlapped to the neighboring light-shielding layer 220, while the second color filter pattern 240 of FIG. 1 that is formed by the green filter pattern 200G is located on another part of the openings H, and is overlapped to the neighboring light-shielding layer 220.

Conventionally, the overlapped parts between the red, the green and the blue filter patterns and the light-shielding layer are used to avoid a light leakage phenomenon. However, human eyes may have different perception degrees for the red light, the green light and the blue light, and the perception degree of the human eyes for the green light is generally higher than that for the red light and the blue light. Therefore, in case that sizes of the overlapped parts between the red, the green and the blue filter patterns and the light-shielding layer are the same, the light leakage phenomenon of the red and the blue filter patterns is relatively not obvious compared to the light leakage phenomenon of the green filter pattern.

Based on the above concept, in the color filter 200 of the present embodiment, the overlapped parts between the red, the green and the blue filter patterns 300R, 300G and 300B and the light-shielding layer are designed to have different sizes. It should be noticed that if such designed is applied to the pixel region 300 having a high aperture ratio, a poor optical quality of the color filter 200 caused by the light leakage can be mitigated.

In detail, as shown in FIG. 2 and FIG. 3, along a short side direction Â, there is a first overlap width W_{OL1} between the red and the blue filter patterns 300R and 300B and the light-shielding layer 220, and there is a second overlap width W_{OL2} between the green filter pattern 300G and the light-shielding layer 220, wherein the second overlap width W_{OL2} is not equal to the first overlap width W_{OL1}.

In the present embodiment, the second overlap width W_{OL2} is greater than the first overlap width W_{OL1}. In other words, the overlapped part between the green filter pattern 300G and the light-shielding layer 220 is greater than the overlapped parts between the red and the blue filter patterns 300R and 300B and the light-shielding layer 220. During an actual application, the first overlap width W_{OL1} is approximately between 1-5 microns (um), and the second overlap width W_{OL2} is approximately between 6-10 microns. In an exemplary embodiment, a ratio between the second overlap width W_{OL2} and the first overlap width W_{OL1} is 8:3.

Generally, the color filter pattern is overlapped to the light-shielding layer by extending to the top of the neighboring light-shielding layer, so that a surface of the color filter pattern is uneven, and therefore the color filter pattern may have a relatively great height difference. However, in the present embodiment, a relatively small height difference can be achieved according to a design of the aforementioned first overlap widths W_{OL1} and second overlap widths W_{OL2}.

In detail, the red filter patterns 300R and the blue filter pattern 300B (i.e. the first color filter pattern 230 of FIG. 1) and the green filter pattern 300G (i.e. the second color filter pattern 240 of FIG. 1) are overlapped to the light-shielding layer 220 by extending to edges of the corresponding openings H and the top of the neighboring light-shielding layer 220. As shown in FIG. 3, there is a substantially same first overlap width W_{OL1} between the red and the blue filter patterns 300R and 300B and the light-shielding layer 220, so that the red and the blue filter patterns 300R and 300B may have a substantially same height difference d1, while the green filter pattern 300G has a height difference d2.

Accordingly, during the actual applications, based on a design of the first and the second overlap widths W_{OL1} and W_{OL2}, the height difference d1 can be controlled to be less than 0.5 um, and the height difference d2 can be less than or equal to 0.5 um. Accordingly, values of the height differences d1 and d2 are quite small, and a difference between the two values is also small. In other words, not only the red, the green and the blue filter patterns 300R, 300G and 300B have tiny height differences d1 and d2, but also great height differences of the color filter patterns generated due to different overlap widths (for example, the second overlap width W_{OL2} is greater than the first overlap width W_{OL1}) formed between the color filter patterns of different colors and the light-shielding layer 220 can be avoided, so that undesired refractions of the light passing through the color filter patterns of different colors can be avoided, and accordingly decreasing of the optical quality of the color filter 200 can also be avoided.

Accordingly, relations between the red, the green and the blue filter patterns 300R, 300G and 300B and the light-shielding layer 220 are as that described above. However, the present embodiment can be studied according to another aspect, as that shown in FIG. 2 and FIG. 3. The red and the blue filter patterns 300R and 300B (i.e. the first color filter pattern 230 of FIG. 1) have a first line width W₁ along the short side direction Â, and the green filter pattern 300G (i.e. the second color filter pattern 240 of FIG. 1) has a second line width W₂ along the short side direction Â. In the present embodiment, the second line width W₂ is greater than the first line width W₁, and a ratio between the second line width W₂ and the first line width W₁ can be

It should be noticed that a profile of each of the red, the green and the blue filter patterns 300R, 30G and 300B has two short sides (parallel to the short side direction Â) and two long sides (perpendicular to the short side direction Â) as that does of a rectangle, though such profile is only a simplified profile illustrated for simplicity's sake. During the actual application, the profiles of the red, the green and the blue filter patterns 300R, 300G and 300B can be slightly different to the even profiles shown in FIG. 2 according to demands of actual products. Moreover, for simplicity's sake, the first and the second line widths W₁ and W₂ are, for example, approximate widths of the red, the green and the blue filter patterns 300R, 300G and 300B along the short side direction Â. Certainly, the actual line widths are determined according to measurement of actual products, which is not limited by the present invention.

### Second Embodiment

The spirit of the present embodiment is similar to that of the first embodiment. In the present embodiment, the displayed image is also formed by the three primary colors of light (red light, green light and blue light). In the first embodiment, the color filter 200 is designed according to a concept that the perception degree of the human eyes for the green light is higher than that for the red light and the blue light, so that the red filter pattern and the blue filter pattern substantially have the same design parameters. Certainly, during the actual application, the color filter can be further designed according to a perception difference of the human eyes for the red light and the blue light. Therefore, the red filter pattern and the blue filter pattern of the present embodiment apply different design parameters to further improve the optical quality of the color filter. The same or like reference numerals in the present embodiment and the first embodiment refer to the same or like elements, and therefore detailed descriptions thereof are not repeated.

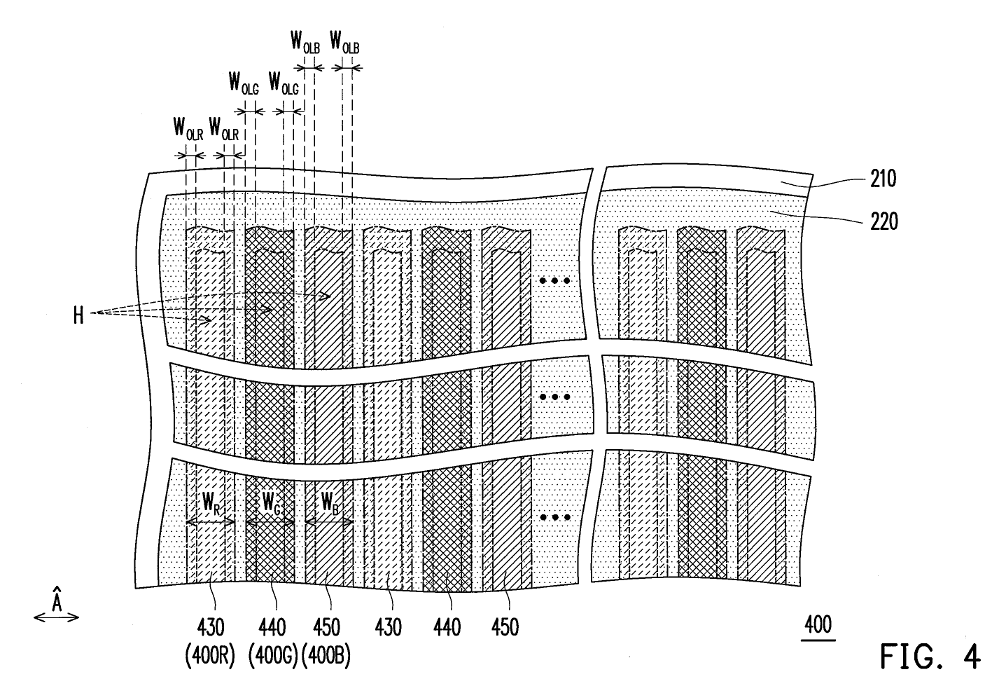

FIG. 4 is a partial top view of a color filter according to another embodiment of the present invention. Referring to FIG. 4, the color filter 400 includes a substrate 210, a light-shielding layer 220, a plurality of first color filter patterns 430, a plurality of second color filter patterns 440 and a plurality of third color filter patterns 450. The light-shielding layer 220, the first color filter patterns 430, the second color filter patterns 440 and the third color filter patterns 450 are disposed on the substrate 210, and the first, the second and the third color filter patterns 430, 440 and 450 are arranged in interlace and parallel. Certainly, the color filter 400 of the present embodiment can further includes other components, though the other components are not illustrated in FIG. 4 for simplicity's sake.

In the present embodiment, the first color filter pattern 430 is a red filter pattern 400R, the second color filter pattern 440 is a green filter pattern 400G, and the third color filter pattern 450 is a blue filter pattern 400B, wherein the red filter pattern 400R, the-green filter pattern 400G and the blue filter pattern 400B are located on the corresponding openings H, and are overlapped to the neighboring light-shielding layer 220.

As described above, the red filter pattern 400R (the first color filter pattern 430) is located on a part of the openings H, and is overlapped to the neighboring light-shielding layer 220, the green filter pattern 400G (the second color filter pattern 440) is located on another part of the openings H, and is overlapped to the neighboring light-shielding layer 220, and the blue filter pattern 400B (the third color filter pattern 450) is located on the rest part of the openings H, and is overlapped to the neighboring light-shielding layer 220.

In detail, along the short side direction Â, there is a first overlap width W_{OLR} between the red filter patterns 400R and the light-shielding layer 220, there is a second overlap width W_{OLG} between the green filter patterns 400G and the light-shielding layer 220, and there is a third overlap width W_{OLB} between the blue filter patterns 400B and the light-shielding layer 220. It should be noticed that the red, the green and the blue filter patterns 400R, 400G and 400B of the present embodiment are overlapped to the light-shielding layer 220 by respectively extending to the edges of the corresponding openings H and the top of the neighboring light-shielding layer 220, which is similar as that described in the embodiment of FIG. 3, and therefore detailed descriptions thereof are not repeated.

It should be noticed that in the present embodiment, the concept that the perception degree of the human eyes for the green light is higher than that for the red light and the blue light is also complied, though the perception degrees of the human eyes for the red light and the blue light are further explored to fine-tune the first and the third overlap widths W_{OLR} and W_{OLB}. Namely, in the present embodiment, the second overlap width W_{OLG} is greater than the first and the third overlap widths W_{OLR} and W_{OLB}, though the first overlap width W_{OLR} is not equal to the third overlap width W_{OLB}. However, the first and the third overlap widths W_{OLR} and W_{OLB} can be determined according to the actual products, and are not limited by the present invention.

As described above, the present embodiment not only has the advantages of the first embodiment, but the first and the third overlap widths W_{OLR} and W_{OLB} can be further fine-tuned to improve the optical qualities of the red filter pattern 400R and the blue filter pattern 400B. Moreover, according to such design, the red, the green and the blue filter patterns 400R, 400G and 400B may have tiny height differences with small deviations. Description of the height difference is as that described in the first embodiment, and therefore detailed descriptions thereof are not repeated.

According to another aspect, along the short side direction Â, the first color filter pattern 400R has a first line width W_{R}, the second color filter pattern 400G has a second line width W_{G}, and the third color filter pattern 400B has a third line width W_{B}. In the present embodiment, the second line width W_{G} is greater than the first and the third line widths W_{R} and W_{B}, though the first line width W_{R} is not equal to the third line width W_{B}. Design parameters of the first, the second and the third line widths W_{R}, W_{G} and W_{B} are determined according to the actual products, which is not limited by the present invention.

In summary, based on the concept that the human eyes have different perception degrees for the red light, the green light and the blue light, in the color filter of the present invention, the overlap widths between the color filter patterns of different colors and the light-shielding layer may have different parameters, so as to improve the optical quality of the color filter. By applying the color filter of the present invention to a display apparatus, display quality of the display apparatus can be effectively improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter, comprising:
a substrate;
a light-shielding layer, disposed on the substrate, and having a plurality of openings arranged in array, wherein the substrate is exposed by the openings;
a plurality of first color filter patterns, disposed on the substrate in parallel, located on a part of the openings, and overlapped to the neighboring light-shielding layer, wherein there is a first overlap width between each of the first color filter patterns and the light-shielding layer; and
a plurality of second color filter patterns, disposed on the substrate, arranged in interlace and parallel to the first color filter patterns, and located on another part of the openings and overlapped to the neighboring light-shielding layer, wherein there is a second overlap width between each of the second color filter patterns and the light-shielding layer, and the second overlap width is not equal to the first overlap width.

2. The color filter as claimed in claim 1, wherein each of the first color filter patterns is overlapped to the light-shielding layer by extending to edges of the part of the openings and top of the neighboring light-shielding layer, and each of the second color filter patterns is overlapped to the light-shielding layer by extending to edges of the other part of the openings and the top of the neighboring light-shielding layer.

3. The color filter as claimed in claim 1, wherein the second overlap width is greater than the first overlap width.

4. The color filter as claimed in claim 3, wherein there is the first overlap width between each of the first color filter patterns and the light-shielding layer along a short side direction, there is the second overlap width between each of the second color filter patterns and the light-shielding layer along the short side direction, each of the first color filter patterns has a first line width along the short side direction, and each of the second color filter patterns has a second line width along the short side direction.

5. The color filter as claimed in claim 4, wherein the second line width is greater than the first line width.

6. The color filter as claimed in claim 1, wherein the first overlap width is between 1-5 microns, and the second overlap width is between 6-10 microns.

7. The color filter as claimed in claim 1, wherein a ratio between the second overlap width and the first overlap width is 8:3.

8. The color filter as claimed in claim 1, wherein each of the first color filter patterns comprises a red filter pattern and a blue filter pattern, and each of the second color filter patterns comprises a green filter pattern, wherein the red filter patterns, the green filter patterns and the blue filter patterns are arranged in interlace and parallel.

9. The color filter as claimed in claim 1, further comprises:
a plurality of third color filter patterns, disposed on the substrate, arranged in interlace and parallel to the first and the second color filter patterns, and located on the rest part of the openings and overlapped to the neighboring light-shielding layer, wherein there is a third overlap width between each of the third color filter patterns and the light-shielding layer, and the first, the second and the third overlap widths are not equal.

10. The color filter as claimed in claim 9, wherein each of the third color filter patterns is overlapped to the light-shielding layer by extending to edges of the rest part of the openings and the top of the neighboring light-shielding layer.

11. The color filter as claimed in claim 9, wherein the second overlap width is greater than the first overlap width and the third overlap width, though the first overlap width is not equal to the third overlap width.

12. The color filter as claimed in claim 11, wherein there is the first overlap width between each of the first color filter patterns and the light-shielding layer along a short side direction, there is the second overlap width between each of the second color filter patterns and the light-shielding layer along the short side direction, there is the third overlap width between each of the third color filter patterns and the light-shielding layer along the short side direction, wherein each of the first color filter patterns has a first line width along the short side direction, each of the second color filter patterns has a second line width along the short side direction, and each of the third color filter pattern has a third line width along the short side direction.

13. The color filter as claimed in claim 12, wherein the second line width is greater than the first line width and the third line width, though the first line width is not equal to the third line width.

14. The color filter as claimed in claim 9, wherein each of the first color filter patterns is a red filter pattern, each of the second color filter patterns is a green filter pattern, and each of the third color filter patterns is a blue filter pattern, and the red filter patterns, the green filter patterns and the blue filter patterns are arranged in interlace and parallel.
